(19) United States
(12) Patent Application Publication
(10) Pub. No.: US 2014/0244280 A1
(43) Pub. Date: Aug. 28, 2014

(54) WEBSITE PROVIDING MEDICAL, DENTAL, VETERINARIAN PROCEDURE COST AND SCHEDULING OPTIONS

(71) Applicant: William R. Fitz, Columbus, OH (US)

(72) Inventor: William R. Fitz, Columbus, OH (US)

(21) Appl. No.: 14/169,510

(22) Filed: Jan. 31, 2014

Related U.S. Application Data
(60) Provisional application No. 61/759,102, filed on Jan. 31, 2013.

(51) Int. Cl. G06F 19/00

(52) U.S. Cl. CPC G06F 19/327; G06F 19/363
USPC 705/2

(57) ABSTRACT

A system and method of providing users with pricing and availability options associated with medical, dental and/or veterinary procedures through an Internet website. Upon entering information regarding a desired service and a desired traveling distance associated with a plurality of care providers offering the desired service, a user is provided with a list of options associated with the desired service, including the name of the care provider, the distance to care provider, the cost of the service and scheduling information. Upon selecting one of the options, the selected care provider is informed that the user desires to schedule the desired service based upon the scheduling information. If the selection is approved, the service is scheduled; if not, the user is informed that their selection is unavailable. The method may additionally include the step of asking the user a series of questions associated with the procedure.

### REFERENCE TO RELATED APPLICATION

This application claims priority from U.S. Provisional Patent Application Ser. No. 61/759,102, filed Jan. 31, 2013, the entire content of which is incorporated herein by reference.

### FIELD OF THE INVENTION

This invention relates generally to medical, dental and/or veterinary treatment and, in particular, to an Internet website providing users with pricing and availability options associated with medical, dental and/or veterinary procedures.

### BACKGROUND OF THE INVENTION

When it comes to medical, dental and/or veterinary procedures, the selection of a particular provider, scheduling option and cost of the procedure can be a time-consuming and challenging process. For example, depending upon a person's schedule, they may elect to pay more to be seen sooner by a desired care provider, or pay less if they can wait for somebody else. Distance also matters in the sense that the overall cost of a procedure should take into account travel time and even fuel cost.

It is now possible for some patients to choose among facilities to perform certain procedures, and such choices may become more common with upcoming changes in health care laws. But the decision regarding which facility to choose may be a daunting task. With regard to magnetic resonance imaging, for example, it may be difficult to ascertain which MRI facility has state-of-the-art equipment, which office has the most experienced technical staff, or physicians who can deliver fast, reliable results. There may also be important questions regarding the MRI system itself, the distance to the facility, and insurance coverage.

### SUMMARY OF THE INVENTION

This invention relates generally to medical, dental and/or veterinary treatment and, in particular, to method of providing users with pricing and availability options associated with medical, dental and/or veterinary procedures through an Internet website.

In accordance with the method, a user enters information at an Internet website regarding a desired service and a desired traveling distance associated with a plurality of care providers offering the desired service. The user is provided with a list of options associated with the desired service, including the name of the care provider, the distance to care provider, the cost of the service and scheduling information. Upon selecting one of the options, the selected care provider is informed that the user desires to schedule the desired service based upon the scheduling information. If the selection is approved, the service is scheduled; if not, the user is informed that their selection is unavailable.

The service may be a medical, dental or veterinary procedure. The method may further include the step of asking the user various questions to determine the best service options, including Zip code to determine options based upon distance; available or preferred dates or times for the desired service; the name of the user's primary care provider, insurance information, and so forth. The method may further include the step of providing the user with feedback ratings associated with the options prior to the selection thereof.

The method may additionally include the step of asking the user a series of questions associated with the procedure. For example, if the procedure is an MRI or CT scan, the system may ask questions regarding height and weight; claustrophobia; allergies to contrast agents; foreign (i.e., metallic) body objects, and so forth.

### BRIEF DESCRIPTION OF THE DRAWINGS

FIG. 1 is a flow diagram illustrating the basic steps associated with the method of the present invention;

FIG. 2 shows a screen display from a prototype website; and

FIG. 3 shows options available to a user through the website discussed with reference to FIG. 2.

### DETAILED DESCRIPTION OF THE INVENTION

This invention resides in a website that helps visitors answer questions regarding medical procedures, locate the most appropriate treatment facilities, choose the best options in terms of provider, cost, scheduling, distance and other factors. While certain embodiments may be presented in terms of medical or dental procedures, the reader will appreciate that the method is applicable to veterinary and other procedure types.

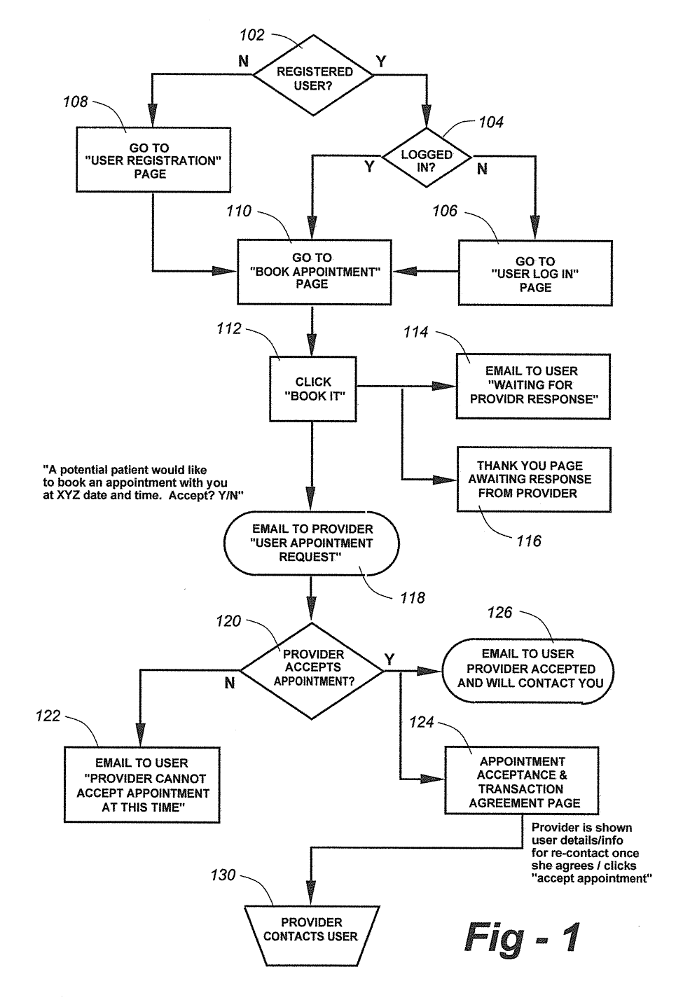

FIG. 1 is a flow diagram that illustrates basic steps associated with the method. A user, if registered at 102, may log into the website at 104. If not logged in, the user is routed to the log in page at 106. If not already registered, the user is diverted first to a registration page at 108. Once properly registered and logged in, the user is sent to a “Book Appointment” page 110.

At the “Book Appointment” page, the user is provided with various options depending upon the type of procedure of interest. As discussed below, multiple links to other pages are provided, enabling the viewer to “drill down” to different levels of detail depending upon need.

If the user is satisfied with their selection, they can actually book the appointment at block 112. At this point, communications are sent to the user including “waiting for provider response” at 114 or 116. A message is sent to the selected provider at 118, providing the provider with information regarding the requested service or procedure. If the provider declines to accept the request at 120, a message may be sent to the user at 122 indicating that the provider cannot accept the appointment at this time, with or without reasons.

On the other hand, if the provider does accept the appointment, a message is sent to the requestor at 126, and details of the appointment are confirmed to the provider at 124. It is expected that the provider contacts the user at 130, for example to confirm the appointment and deliver an information package regarding the service or procedure to be provided, how to prepare for it, and so forth.

In booking a particular procedure, initial web pages may have tabs to select procedures or other treatment options to schedule or purchase. Table I lists possible tab functions associated with a medical/surgical embodiment of the invention. More or fewer tabs may be provided in accordance with the way in which services are rendered. For example, MRI and CT scans and Physical therapy services are often bundled at outpatient testing facilities.

TABLE I
PROCEDURE/TREATMENT OPTIONS

| TAB | SELECTION |
|---|---|
| 1 | Physician Appointment |
| 2 | MRI Scan |
| 3 | CT Scan |
| 4 | Lab Work |
| 5 | Physical Therapy |
| 6 | Occupational Therapy |
| 7 | Medications/Pharmacy |
| 8 | Prosthetics/Orthotics |
| 9 | Optical Products |
| 10 | Bundled Procedures (total hip, knee, shoulder |
| | replacement, heart bypass, ACL |
| | reconstruction, face lift, etc.) |

An important aspect of the invention is that procedure cost is not the only option provided to users in making a choice regarding care. Once a user click on the desired service, the system asks a series of questions to determine the best overall treatment options. For example, subsequent screens might ask:
What is your zip code?
How far are you willing to travel?
How much are you willing to spend?
What dates/times are you available?
What dates/times do you most prefer?
What is the name of the ordering physician?
What type of health insurance do you have?
Questions specific to a desired service such as MRI might include the following:
What is your height and weight?
Are you claustrophobic?
Do you have allergies to contrast agents?
Do you have any foreign (i.e., metallic) objects in your body?
Do you have a pacemaker or defibrillator?
Have you had a colonoscopy or endoscopy in the last 6 weeks?
Do you have aneurysm brain clips or ear implants?
Do you work with metal?
What body part is to be scanned?
Do you have kidney disease or hypertension?
Do you have an authorization number that is often obtained by the ordering physician from your insurance company?
Or, for physical therapy:
Do you have a prescription?
What is your diagnosis?
What is your referring doctor's name and phone number?

After these filters are in place, one or more subsequent pages will show a listing of the options available with location, price, times available, and possibly other information such as feedback by other users (both the patient and the referring physician) on that facility, or service. A user may then click on the one they want and a scheduling page with info like name, address, email, contact numbers, disclaimers, credit card number to reserve the appointment, authorization number for the procedure (to be obtained by the referring doctor).

Once scheduled, a page with all info to print and present to the facility at the time of the appointment. Also give them the number of the facility to call them if needed and the facility may call them to confirm the appointment and review any pre-procedure protocols. For example, some MRI scans require contrast and that requires lab work in people with kidney disease or are over the age of 60. Also a FAX may be sent to the referring physician to inform them of the time, place and info on the MRI scanner for the referring physician to review and if unacceptable make a change.

On the back end of these filters, the MRI scanner would be matched with the part to be scanned (since not all scanners can scan all body parts). Another important aspect of the invention may be in the consumer feedback on the service provided. For example, an email might be automatically sent out after the appointment that would ask a few questions on their experience . . . and quality /patient satisfaction info could be developed. The return email may be uploaded in the form of a five star system that rates the facility cleanliness, staff professionalism, staff friendliness, wait time, time spent explaining the procedure, location, ease of parking, overall experience. Then the physician might be surveyed and asked if the service was an MRI about the quality of images, ease of use of the MRI software, quality of the MRI report supplied by the reading physician. If physical therapy was the service, questions would be the same as the MRI for the patient and the physician would be asked about the appropriateness of the treatment provided and quality of the reports sent by the therapist.

On the back end, a provider may agree to sign up his site on the web site itself and pay with a credit card with certain terms of payment and agreements of service. This is a very important aspect of the site since, for example, an insurance company may pay significantly to be allotted a drop down spot on the initial filter page.

A challenge will be allowing the site to view and search the schedules of the service providers; as such, they may all have to get on a unified, dedicated scheduling database if there is no way to search their schedules.

The site will also search the info provided by the insurance company and show the negotiated reimbursement to each facility that is on the insurance plan for that patient to show that they are a covered provider and the rates. Next to that rate will be a cash rate that the patient may elect and pay cash at the time of service if it is less than the negotiated rate. They can then seek reimbursement from the insurance company if they have met their deductible or the facility will notify the insurance company of the charge to apply it to the patient's deductible.

There may be two types of quality ratings . . . one is the consumer rating, the other would be a professional evaluation by the referring doctor of the service (also ranked on a 5 star system). This would allow for a service that is superior to charge more for their service . . . a real marketplace for healthcare . . . for the first time allowing price to vary with quality and convenience.

The site may also include a section to fill out if desired regarding past medical history with illnesses, previous surgeries, medications, allergies, family history, and social history. The site will be password protected and will need some language regarding confidentiality and some references to the HIPAA laws. Once an appointment is made the patient will be prompted to fill out or review the past medical form and authorize that it be sent with their current appointment. They do not need to do this for and appointment but it will be suggested by the site.

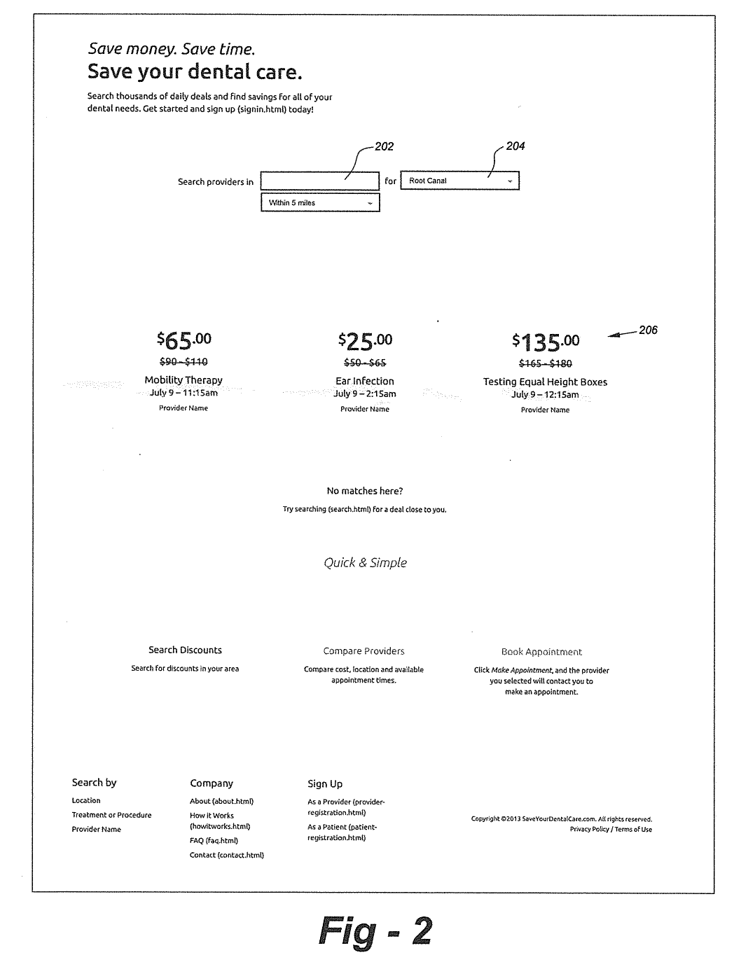

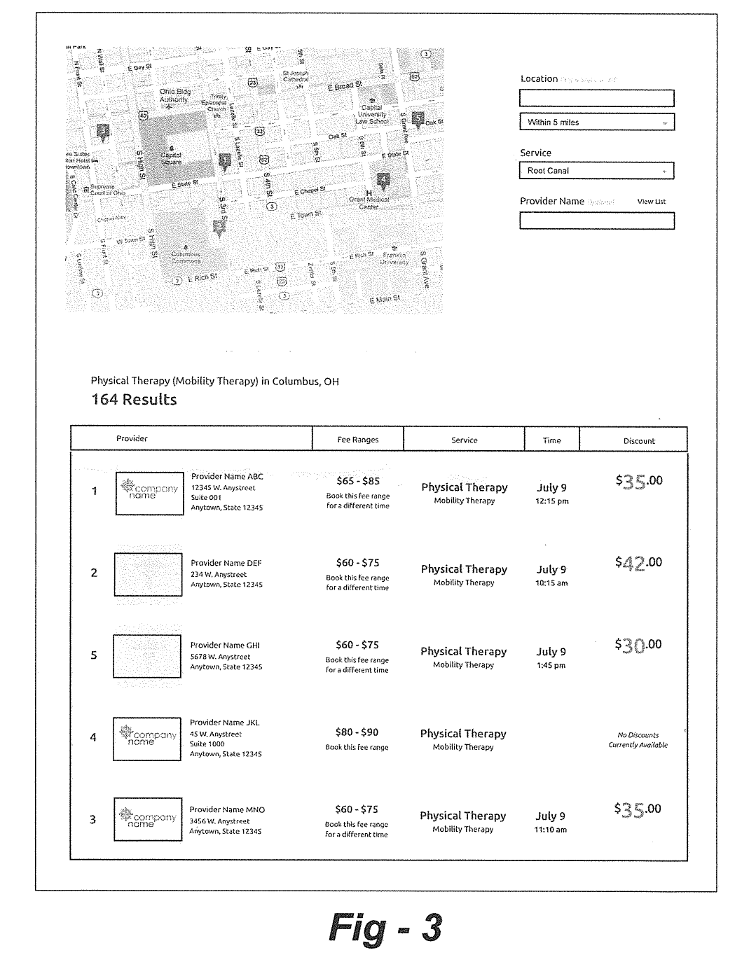

FIGS. 2 and 3 illustrate screen displays from a prototype website according to the invention called “save your dental care.” Regions 202 and 204, which may include pull-down menus, enable the visitor to select providers within a particular distance range and the type of procedure, respectively. Special offers 206 may be listed as well even without filling in the fields 202, 204. Once a user has selected a location within 5 miles for a root canal, 164 results are displayed as shown in FIG. 3, which lists provider name, fee ranges, the type of service provided, available time slots, and discount. As can be seen, at least 6 pages are provided in this case enabling the user to scroll though and select the combination of features that best fits their needs.

Another aspect of the invention would be the inclusion of advertising specific material to the requested service that would be of interest to the patient that will be shown on their response page. For instance if a user is looking for something in the veterinary line, ads for pet stores or pet food may be displayed for that user to view and would also provide a link to their web sites for more information or purchase.

1. A method of providing a user with care provider options, comprising the steps of:
entering, by a user at an Internet website, information regarding a desired service and a desired traveling distance associated with a plurality of care providers offering the desired service;
providing the user with a list of options associated with the desired service, including the name of the care provider, the distance to care provider, the cost of the service and scheduling information;
selecting, by the user, one of the options;
informing the care provider selected by the user that the user desires to schedule the desired service based upon the scheduling information; and
scheduling the service by the care provider if the selection has been approved; or informing the user that the selection is unavailable.

2. The method of claim 1, wherein the service is a medical, dental or veterinary procedure.

3. The method of claim 1, further including the step of asking the user their Zip code to determine options based upon distance.

4. The method of claim 1, further including the step of asking the user for available or preferred dates or times for the desired service.

5. The method of claim 1, further including the step of asking the user for the name or their primary care provider.

6. The method of claim 1, including the step of providing insurance information by the user to determine which of the options are available.

7. The method of claim 1, including the step of providing the user with feedback ratings associated with the options prior to the selection thereof.

8. The method of claim 1, wherein:
the service is a medical, dental or veterinary procedure; and
further including the step of asking the user a series of questions associated with the procedure.

9. The method of claim 1, wherein:
the service is an MRI or CT scan; and
further including the step of asking the user one or more of the following questions regarding the procedure:
what is your height and weight?,
are you claustrophobic?,
do you have allergies to contrast agents?,
do you have any foreign (i.e., metallic) objects in your body?,
do you have a pacemaker or defibrillator?,
what body part is to be scanned?, and
do you have kidney disease or hypertension?
